(19) United States
(12) Patent Application Publication
(10) Pub. No.: US 2003/0178512 A1
(43) Pub. Date: Sep. 25, 2003

(54) Attachment device for attaching a spreader to a vehicle

(76) Inventor: Mark Kenny, Jensen Beach, FL (US)

Correspondence Address: TANGENT LAW GROUP, 1201 PENNSYLVANIA AVE, WASHINGTON, DC, 20004, US

(21) Appl. No.: 10/393,012

(22) Filed: Mar. 21, 2003

Related U.S. Application Data
(60) Provisional application No. 60/366,233, filed on Mar. 22, 2002.

(51) Int. Cl. A01C 3/06

(52) U.S. Cl. 239/650

(57) ABSTRACT

An attachment device attaching a push spreader having wheels and an axle to a vehicle, having a frame with at least one attachment frame member. The attachment device also has at least one receiving element that engages the spreader. A motor driving a contact member is provided, so that the contact member drives the wheels and the axle of the spreader and thereby operates the spreader.

### CROSS-REFERENCE TO RELATED APPLICATIONS

This application claims the priority of U.S. provisional patent application No. 60/366,233, filed on Mar. 22, 2002, which is incorporated herein by reference.

### BACKGROUND OF THE INVENTION

1. Field of the Invention

The invention relates to an apparatus, kit, method and system attaching a commercially available spreader mechanism to a vehicle.

2. Background of the Invention

A principal problem in the landscape industry is the cost of labor to operate equipment, especially manually driven equipment. This is true of all aspects of landscape contracting, but is especially true in the periodic application of broadcast media, such as fertilizers, seeds, or pesticides. Typically, the infrequent application of these materials and the need for costly specialized equipment to effectively treat large turf areas requires landscapers to forgo the necessary treatments or sub-contract the treatments to a specialized service provider. Landscape contractors cannot compete with the specialized fertilization or pest control operators who are equipped with state-of-the-art equipment, such as dedicated, motorized spreaders and sprayers that reduce labor costs. These pieces of equipment are expensive but increase profit margins in the periodic application of broadcast media, like fertilizers and pesticides, due in part to a significant reduction in labor cost.

There are many self-contained, dedicated fertilizer spreaders on the market that attach to lawn mowers and utility vehicles. There are also less expensive spreaders that are manually pushed. Both of these types of spreaders are ideal for spreading all types of granular, powdered, and pelletized materials, such as, for example, fertilizers, seeds, insecticides and ice-melting pellets. The dedicated motorized spreaders are, however, bulky, and expensive and are limited in use to broadcasting media from the vehicles to which they are attached. Thus, they are limited in utility to areas of turf that justify the use of and are accessible to a vehicle. These motorized dedicated spreaders typically consist of a frame on an axle, a dedicated hopper, and an electric drive motor and wiring to attach to the vehicle. They come in towed and forward facing versions, but must be attached to a vehicle to function. They are driven solely by the drive motor and must have this motor and a power source, typically the vehicle battery, to operate. The attachment of these dedicated devices is complex and time consuming.

The Ev-N-Spread M21, manufactured by EarthWay Inc., is one example of this typical dedicated spreading attachment utilized by professionals in the industry. The attachment has a 12-volt motor mounted inside a high volume hopper capable of handling 100 kilograms of media. The system uses a coated stainless steel chassis. The chassis is mounted to the vehicle on a tow frame with separate wheels and axle similar in height and proportion to the vehicle. Each spreader includes a power cord with an on/off switch, and shut-off activation cord for control by the vehicle driver.

Another example is the Model 501 Electric Broadcast Spreader For Commercial Riding and Walk-Behind Mowers produced by JRCO. The Model 501 also has a stainless steel frame. The spreader is front-mounted with a foot-operated gate. The polyethylene hopper has a capacity of 2.2. cu. ft. or 130 pounds capacity. The spreader attaches to a mounting bar with pins and faces forward.

The advantages of utilizing an electronically operated spreader mounted on a vehicle are two fold. Firstly, it is driven by an electronic motor, which provides a constant spread and broadcast pattern with an increased ground speed for the broadcast media. This results in a more even dispersal pattern and a more uniform application of the media. Secondly, as it is not reliant on the operator to push it, the specialized vehicle mounted spreaders greatly reduce operator fatigue and labor costs over the manual push-type spreaders. However, these dedicated motorized spreaders are prohibitively costly for most professional landscapers and residential home owners. They generally have appeal only to landscape contractors who have a large enough fleet of equipment to absorb the cost of these dedicated spreaders or to specialized service providers whose services are dedicated to fertilization, seeding, pest eradication or other periodic application services and, therefore, can justify the cost of the dedicated equipment.

A further problem with the currently available motorized spreaders is the motors are often directly exposed to the caustic chemicals in the typical broadcast media. These very corrosive chemicals must be rinsed from the motors after use. Thus, having the motors directly attached to the hoppers is problematic and costly in both clean-up and eventual maintenance costs.

Instead of these dedicated electric spreaders, the typical landscape contractor or residential consumer uses manual equipment that is significantly more labor intensive. Cost constraints for both the professional user and the residential user prohibit the use of dedicated spreader equipment. This often results in an insufficient frequency and duration of application of the broadcast media, such as fertilizers. This in turn results in a lower quality of turf or lower quality of landscaping.

However, a significant number of landscape contractors and residential consumers already have manual push spreaders. Examples of these types of push spreaders, typically broadcast spreaders, include the spreaders made by LESCO, Inc. and Spyker Spreaders Inc., for instance Spyker's model numbers 298 and 88. Although attempts have been made in the past, for example, U.S. Pat. No. RE 32,067 to Emory and U.S. Pat. No. 5,485,963 to Walto et al., there has been no effective and commercially viable way to mount the spreader. Both the '067 and '963 patents utilize drop spreaders, not commonly used in commercial applications. They are difficult to mount to the walk behind mowers shown and are driven directly from the mower wheels. Furthermore, none of the heretofore solutions has had any commercial success. Therefore, a need still exists to facilitate a cost effective, less labor-intensive way of utilizing these push spreaders to achieve the advantages of the dedicated spreaders without requiring the purchase of the more costly, maintenance intensive dedicated spreaders.

### SUMMARY OF THE INVENTION

The instant invention is directed to an inexpensive attachment for mounting push spreaders on a vehicle, such as a mower or an ATV/Utility Vehicle, while maintaining their functionality and operability as spreaders apart from the attachment. The invention receives and retains the push spreader on the self-propelled vehicle and a drive unit is used to engage the spreading mechanism. In an exemplary embodiment, the drive unit can be run from the same power source as the vehicle or the drive unit can be self-contained with its own power source. In the exemplary embodiment, the drive unit engages and turns the wheels of the spreader, thus turning the spreading mechanism typically driven by the manual pushing and movement of the wheels. The attachment can also be a kit used in combination with the push spreader and the vehicle. The push spreader can also be modified to mount specialized components of the kit to assist in engagement with the attachment or in place of parts of the instant invention, without departing from the spirit of the invention. For instance, the spreader can incorporate components of the instant invention into its frame to provide for easier mounting. The instant invention can thus achieve the same results as a dedicated electric spreader for a significantly lower cost to the consumer and still allow the spreader to be operated manually.

An object of the instant invention is to provide for a cost saving attachment for mounting commercially available push spreaders on vehicles with variable sped control accessible to an operator.

A further object of the instant invention is a kit to mount a commercially available push spreader on a vehicle, in particular a lawnmower or ATV.

A still further object of the instant invention is to provide a low cost alternative to dedicated electronically driven spreader attachments.

Yet a further object of the invention is to provide a cost-effective system for mounting a push spreader on a vehicle.

Another object of the invention is to provide for an adjustable mounting attachment to accommodate a variety of commercially available push spreaders.

Still a further object of the invention is to provide a variable speed electric motor to drive the push spreader.

The invention includes an apparatus, a kit, a method, and a method for attaching a kit.

The apparatus of the instant invention comprises an attachment device for attaching a spreader having wheels to a vehicle. The device has a frame having first and second attachment frame members and at least a first and a second receiving element that engage the spreader. A motor driving a contact member is also provided, so that the contact member drives the wheels of the spreader and this operates the spreader. The contact member in the exemplary embodiment engages the wheels. However, the contact member can engage the wheels through and intermediary, such as a belt or chain, or directly drive the axle and achieve the same results. The attachment can also further comprise a first receiving element extending from said first attachment frame member and a second receiving element extending from said second attachment frame member.

The attachment device can have an L-shaped frame. The first and second attachment frame members of the L-shaped attachment frame can form an angle of between about 20 degrees and about 160 degrees relative to one another. The first and second attachment frame members of the L-shaped attachment frame can also form an angle of about 90 degrees relative to one another. The first and second attachment frame members of the L-shaped attachment frame can form an angle relative to one another that is adjustable. The first and second attachment frame members of the L-shaped attachment frame of the attachment device can also be coupled by a hinge at an apex of the frame and the angle between the frame members can be adjusted between an angle of about 20 degrees to an angle of about 160 degrees relative to one another.

The attachment can further comprise support mounts and a support mount holder. The support mount holder can be coupled to the vehicle and the support mounts can engage the support mount holder.

The attachment device can further comprise an elevation adjustment mechanism. The elevation adjustment mechanism can be located proximate to the support mount holder. The elevation adjustment mechanism can be, for example, one of a push-button or a pin and hole type mechanism. The attachment can further comprise at least one adjustment mechanism adjusting the position of said at least first and second receiving elements. The attachment can also comprise at least one set of further receiving elements located opposite one another and at an angle to one of said at least first and second receiving elements. An adjustment mechanism can be provided for each receiving element. The at least one set of further receiving elements can be separated at a first distance relative to one another, this first distance being adjustable through an adjustment mechanism. The attachment device can include an adjustment mechanism for the first and/or the second receiving elements, wherein the adjustment mechanism is a plate and an adjustable fastening mechanism coupling said plate to said frame. The attachment device can include a plurality of receiving elements. In the device, each of the adjustment mechanism(s) can be a plate containing each of the receiving elements and coupled to the frame with an adjustable fastening mechanism. The adjustable fastening mechanism can be, for example, a wing nut and a carriage bolt.

The attachment device can also have at least one set of further receiving elements that can be separated equidistant relative to one another on the frame. The at least one set of further receiving elements can also separated equidistant relative to one another on said frame. The at least one set of further receiving elements can also be separated at a first distance relative to one active, this first distance being adjustable through an adjustment mechanism.

The attachment device motor can have a means for adjusting the speed of the motor. The attachment can have the means for controlling the speed of the motor mounted on the motor. The attachment device can also have the means for controlling the motor mounted on the vehicle apart from the motor. The means for controlling said motor can also be removably affixed to the vehicle. The means for controlling the motor can be removably affixed, for example, by a magnet.

The instant invention also comprises a kit for attaching a spreader with wheels to a vehicle comprising a mounting mechanism which is coupled to the vehicle and a support frame which is coupled to the mounting mechanism and into which the spreader is inserted. A drive unit from the kit is mounted on the support frame so that the drive unit engages the wheels of the spreader. By driving the wheels of the spreader, the spreader is operated and the broadcast material is distributed.

The method of the invention comprises both a method of assembling a kit for attaching a spreader to a vehicle and a method of mounting a spreader on a vehicle with an attachment. The steps of the method include mounting a support mechanism to the vehicle. Mounting a support frame on the support mechanism. Mounting a spreader with wheels on the support frame and engaging the wheels of the spreader with a motor to operate the spreader.

The above description, objects, and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows a side view of a conventional spreader mechanism, vehicle, and the instant invention.

FIG. 2 shows a front view of the conventional spreader and the instant invention.

FIG. 3 shows a rear view of the conventional spreader and the instant invention.

FIG. 4 shows a further embodiment of the instant invention having a variable speed motor and motor adjustment control.

FIG. 5 shows a side view of the device of FIG. 4 with a control mechanism to control the motor.

FIGS. 6A and 6B show a side view of a further embodiment of the instant invention with a hands-free control mechanism.

FIG. 7 shows a side view of a further embodiment of the instant invention with adjustment mechanisms.

### DETAILED DESCRIPTION OF THE INVENTION

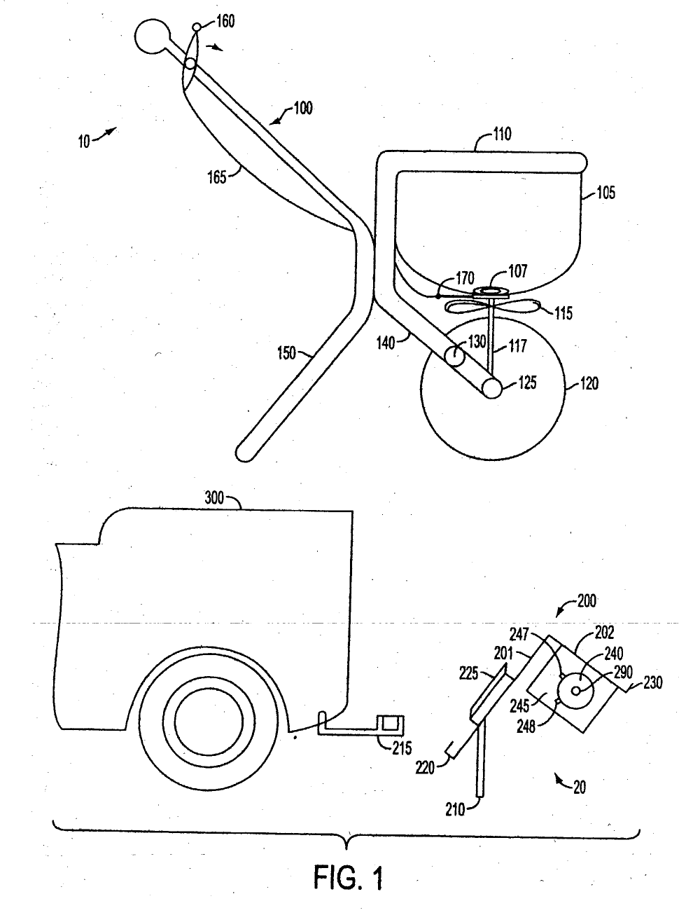

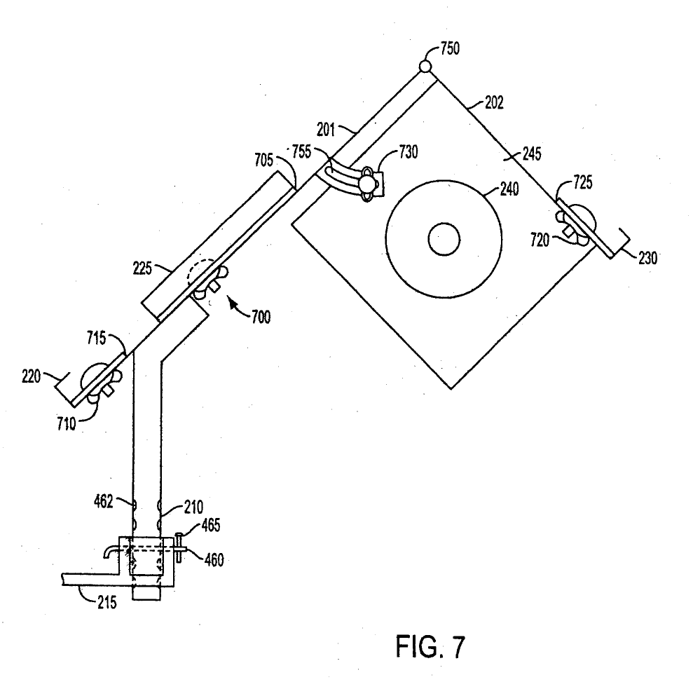

The instant invention is directed to a specialized mounting bracket for mounting a conventional broadcast type spreader. FIG. 1 shows a side view of a conventional spreader mechanism, vehicle, and the instant invention. A conventional broadcast fertilizer or spreader 10 includes a spreader frame 100. The spreader frame having a bucket support sub-frame 110 which holds a bucket 105. Located at the bottom of the bucket 105 is an outlet 107. The material to be broadcast is placed in the bucket 105 and issues from the outlet 107. The material can be for example fertilizers, seeds, insecticides and ice-melting pellets. The outlet has a feed-adjustment mechanism 170 to control the rate of release of the material. Below the feed adjuster mechanism 170 is a spreader or broadcaster mechanism 115. The broadcaster mechanism 115 broadcasts the material in an area around the device. The feed adjustment mechanism 170 is connected to a control linkage 165 and a spreader mounted control mechanism 160. The spreader frame 100 extends further down into a first set of frame legs 140. Located between the first set of frame legs 140 is a reinforcement bar 130 and below this is an axle 125 with wheels 120 mounted thereon. Extending rearwardly from the spreader frame 100 is a second set of frame legs 150. The spreader 10 depicted in FIG. 1 is similar to commercially available spreaders. Variations in the actual components and the placement of the components in the spreader would be well known to those of ordinary skill in the art. Accommodating such variations are, therefore, well within the spirit of the invention, and, in fact, a further embodiment of the instant invention, as described below in relation to FIG. 7, specifically provides for adjustment mechanisms to accommodate variations in the parts and placement of parts in the commercially available spreader.

The typical manner in which the conventional push or manual spreader operates is by manually pushing the spreader 10 so that wheels 120 are turned on the axle 125 which in turn engages a cross-link set of intermeshing gears to turn spreader axle 117 which turns the broadcast mechanism 115. The media to be broadcast is released through the outlet 107, governed by the feed adjust mechanism 170 which is controlled through control linkage 165 and the spreader mounted control mechanism 160. As the device is propelled forward the broadcast or spreader mechanism 115 broadcasts the media in an area around the device. As mentioned previously, this manner of fertilizing is impractical for large tracks of land, such as golf courses, commercial properties, or large estates, as it is extremely labor-intensive. The instant invention reduces the cost of labor in employing the device and avoids the capital cost of purchasing a fully automated, dedicated, separately driven mechanism to be attached to a vehicle such as a lawn tractor or ATV by utilizing this conventional push spreader.

The instant invention provides an attachment 20 having an attachment support frame 200 for mounting the spreader 10. In the exemplary embodiment depicted, the attachment support frame 200 is an L-shaped frame, however, the frame is not limited to this configuration. The attachment support frame 200 has attachment supports 210 extending from the frame, which engage corresponding support holders 215 attached to the vehicle 300. The attachment support frame 200 has a first attachment frame member 201 and a second attachment frame member 202. The attachment 20 engages the second set of legs 150 of the spreader frame 100, engaging, in the exemplary embodiment depicted, the lower most structure of the second set of legs in a first receiving element 220. To prevent lateral movement of the device, in the exemplary embodiment, a further set of receiving elements 225 extend from the attachment support frame 200. The second set of legs 150 of the fertilizer frame are thus engaged by the first attachment frame member 201 of said attachment support frame 200. Additional or fewer receiving elements can also be utilized to stabilize and support the spreader. Similarly, a single frame member could be utilized to support the spreader with an appropriate number of receiving elements, this being limited or dictated by the weight of the spreader 10 and the media placed in bucket 105. The space between the first receiving element 220 and the further set of receiving elements 225 is preferably formed of solid material. However, the space between the further receiving elements 225 extending from the first attachment frame member 201 can also be cutout to reduce material production costs.

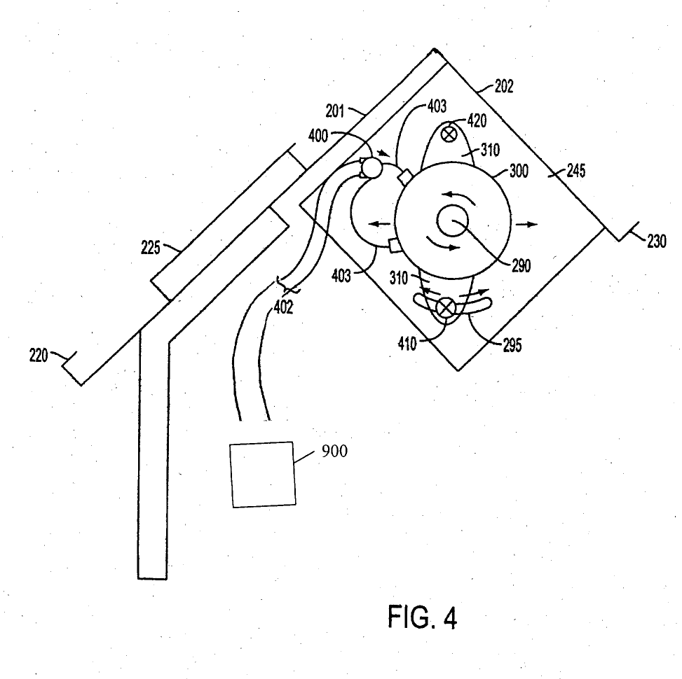

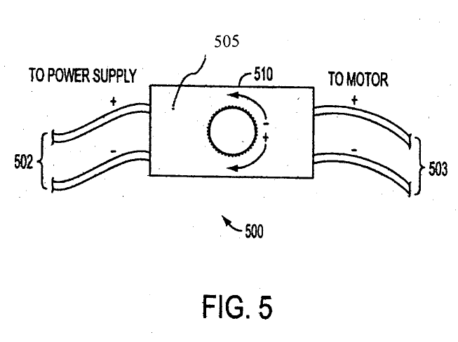

On a second attachment frame member 202 of said attachment support frame 200 in the exemplary embodiment depicted, a second receiving element 230 extends from the face of the second attachment frame member 202. The second attachment frame member 202 is solid in this embodiment. By providing a solid second attachment frame member 202 the caustic materials, such as fertilizer, typically being spread by the spreader are prevented from landing on the motor 240. A plastic guard can also be provided. The guard (not shown) would preferably attach to the back of the second attachment frame member 202 of the spreader frame to deflect material coming back toward the vehicle. Motor-mounting bracket 245 supports the motor 240 and extends from the attachment support frame 200. The exemplary motor is an electric motor. The motor 240 in the exemplary embodiment is connected to the electrical power source of the vehicle 300 by a wiring harness (not shown in FIG. 1) connected to the electrical leads 247, 248. In a further embodiment, depicted in FIGS. 4 and 5, the speed of the motor is adjustable and a control unit is provided between the contacts 247, 248 and the power supply.

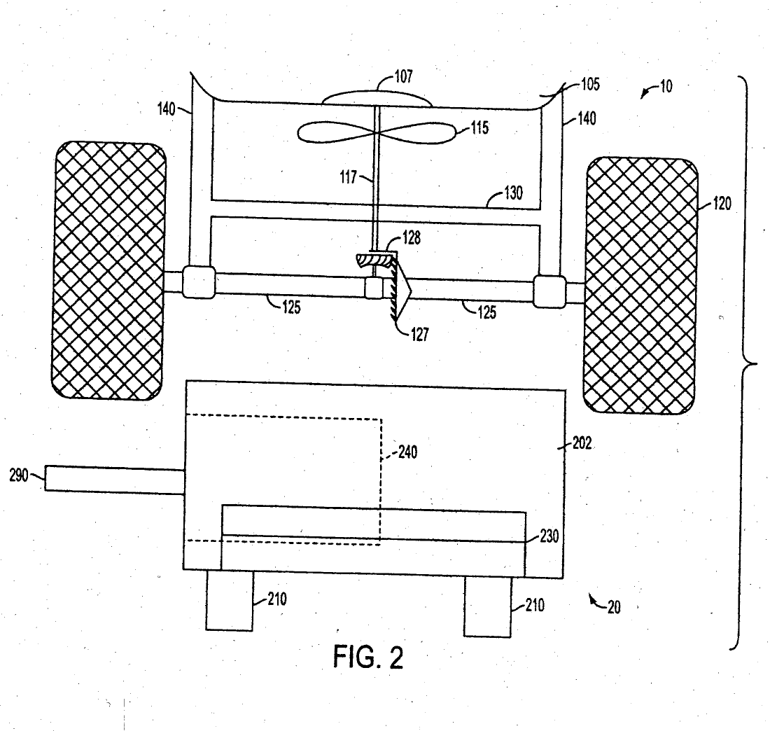

FIG. 2 shows a front view of the conventional spreader and the instant invention. As described above and more clearly seen in FIG. 2, the conventional spreader has wheels 120 connected to an axle 125. Mounted to the axle 125 is a vertical gear 127. The vertical gear 127 engages horizontal gear 128. The horizontal gear in turn is attached to spreader axle 117. The spreader axle 117 turns the broadcast mechanism 115. The axle in the instant invention is free to turn as the second receiving element 230 engages reinforcement bar 130, although other support or receiving members may be utilized so long as the wheels 120 and axle 125 are free to rotate. The motor 240 of the instant invention drives contact member 290, which makes direct contact with the wheels 120 of the spreader in this embodiment. The contact member may make indirect contact through an intermediary, such as a chain or belt, or may directly drive the axle, which in turn drives the spreader. This engagement drives the conventional spreader 10 and its wheels 120 in the same manner as when it is pushed manually. Thus, by allowing axle 125 to turn and by engaging wheels 120 with the contact member 290 that is turned by motor 240 the broadcast mechanism 115 is allowed to turn and, thereby, spread the media contained in the bucket 105.

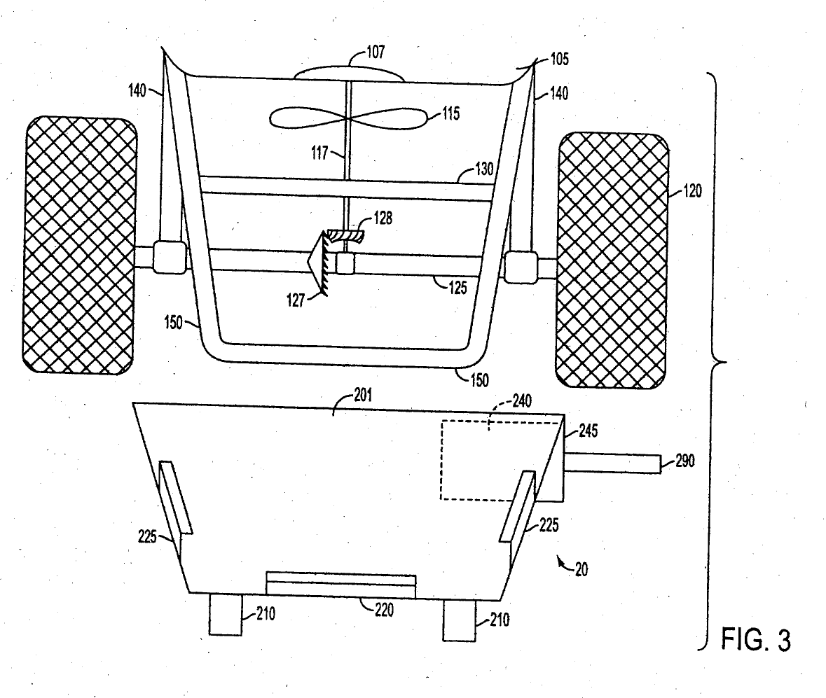

FIG. 3 shows a rear view of the conventional spreader and the instant invention. The second set of legs 150 are shown. As the spreader 10 is placed into the instant invention, the second set of legs 150 are lowered to engage the further receiving elements 225 and simultaneously come to rest atop the first receiving element 220. The second set of legs 150 are tapered in the exemplary embodiment shown but can be straight. Similarly, the further set of receiving elements 225 may be placed at any angle to accommodate the spreader. Extending from the first attachment frame member 201 are supports 210 for mounting the attachment 20 in support holders 215 which are attached to vehicle 300 as shown in FIG. 1. The wheels 120 of spreader 10, once the spreader is lowered, engage contact member 290 and are driven as described above. This in turn operates the broadcast spreader mechanism 115 to spread or broadcast the media.

FIG. 4 shows a further embodiment of the instant invention having a variable speed motor 300 and a motor speed adjustment control 400. The motor speed adjustment control is preferably a variable speed switch built into the motor support for easy access and setting of the speed at which the spreader 10 will be operated. The variable motor speed adjustment control 295 is connected to the motor through a first set of electrical connectors 403 and to the power source 900 through a second set of electrical connectors 402. In the exemplary embodiment depicted in FIG. 4, the power source is a stand-alone 12-watt battery. This embodiment facilitates the installation of the invention on self-propelled law mowers with simple magnetic starters. Additionally, in the embodiment shown in FIG. 4, motor mounts 310 are a motor adjustment mechanism with motor adjustment securing members 410 and 420. The mechanism includes a channel 295 that is provided so that securing member 410 can be moved freely to allow for adjustment of the position of the contact member 290. Thus, the position of contact member 290, extending from motor 240, can be adjusted to accommodate variations in wheel placement and wheel size.

FIG. 5 shows a side view of a removably mountable speed control. The removably mountable speed control 500 controls the motor speed in a way similar to the integrated motor speed adjustment control 290 shown in FIG. 4. The releasably mountable speed control 500 can be similar to a dimmer switch, blade switch, or a rheostat switch for hand operation or a push button variable speed switch or stepper switch for foot operation. A first set of electrical connectors 502 lead from the power supply and a second set of electrical connectors 503 lead to the motor. A dial type switch is shown in the exemplary embodiment of FIG. 5. By turning the switch the motor speed can be adjusted. These types of switches can be mounted in a box 505 with magnetic base for attaching anywhere on the vehicle 300, and are also easily removable.

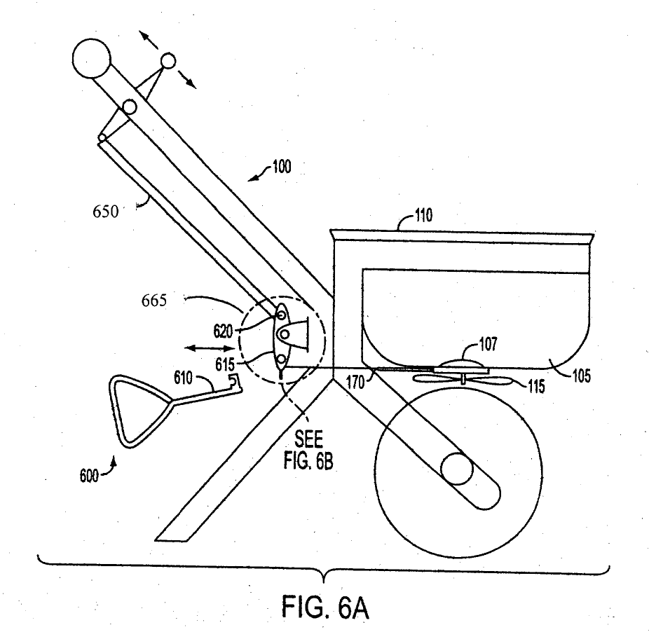

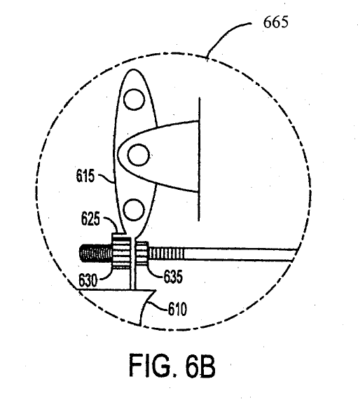

FIGS. 6A and 6B show a side view of a further embodiment of the instant invention with a hands-free control mechanism. FIG. 6A shows the exemplary embodiment of providing hands-free control of the flow of material from the spreader 10 by providing control element 600 and control linkage 665. A spreader mounted control mechanism 160 is connected by control cable 650 to control linkage 665. As seen in FIG. 6A, the exemplary control element 600 connects to linkage 665 to operate the feed adjustment mechanism 170. This provides for hands-free operation of the spreader if the control element 600 is, for example, placed on the lower mower deck for foot operation. Alternatively, the control element 600 can be mounted high and operated by hand from the driving position.

FIG. 6B shows a close-up of the control linkage 665. The control element 600 comprises a control arm 610, which connects to the lower portion 615 of control linkage 665. The control linkage 665 has an upper section 620 connecting to the spreader mounted control mechanism 160 through the control cable 650. The control element 600 can be connected to lower portion 610 as shown in FIG. 6B. In the exemplary embodiment shown adjustable fasteners 625 and 635 are used to attach the control element 600 to the linkage 665 through control arm 610. The operation of the feed adjustment mechanism 170 can be through control element 600 or through the spreader mounted control mechanism 160. This gives the operator a hands-free capability for opening and closing of the spreader feed mechanism 170 if the control cable 162 is connected to control element 600. It is also possible to disable the spreader mounted control mechanism 160 by disconnecting the control cable 650 from the control linkage 665.

FIG. 7 shows a side view of a conventional spreader and a further embodiment of the instant invention with adjustment mechanisms. The adjustment mechanisms allow the attachment 20 to accommodate variations in the parameters of the conventional push spreader 10. An exemplary embodiment of an adjustment mechanism is seen in FIG. 7, a wing nut 700 is mounted on the attachment support frame 200 with a carriage bolt. The bolt extends through a plate 705 that contains first receiving element 220. The bolt and wing nut 700 are mounted in a slot cut into the plate 705. The plate 705 is thus slidable on top of the attachment support frame 200. The wing nut allows for easy adjustment of the distance between the receiving members 225. Similarly, wing nuts 710 and 720 are mounted with carriage bolts through plates 715 and 725, respectively, to adjust the remaining receiving members 220 and 230 respectively. The angle of the first attachment frame member 201 in relation to second attachment frame member 202 is also adjustable in this embodiment through hinge 750 connecting each of the frame members 201 and 202. A curved member 755 extends from attachment support frame 200 with a channel for wing nut and a bolt 730. The wing nut 730 allows for securement of the hinged first and second attachment frame members at the desired angle relative to one another.

Also shown in FIG. 7, at the support holders 215, in the exemplary embodiment, support members 450 have an elevational adjustment mechanism. In the embodiment show multiple holes 462 with securing pins 460 and clevis pins 465 are provided as securing or engaging mechanisms and are used to adjust the elevation of the frame relative to the spreader. This example is non-limiting, additional adjustment mechanisms may include toothed fasteners, toothed grooves with adjustable holding pins, rack and pinion mechanisms, spring loaded push pins and holes, securing pins or similar known adjustment mechanisms for use in providing variation in the configuration of the receiving members for engaging the support frame 200, the elevation of the attachment, or the angle of the support frame.

The device can also be provided, in a preferred commercial embodiment, as a kit for attaching a spreader 10 with wheels 120 to a vehicle. The kit can include, in an exemplary embodiment, a mounting mechanism, such as support holders 215, which are coupled to the vehicle 300. An attachment support frame 200 is included that is coupled to the mounting mechanism 215 into which the spreader 10 is inserted. A drive unit 240 can be included in the kit to be mounted on the support frame 200 so that the drive unit engages the wheels of the spreader and operates the spreader. Additional components of the kit can include a wiring harnes and a switch. The wiring harness may also include the switch as an intergral component and the switch may be removably mountable on the vehicle after installation.

A preferred method of attaching a spreader to a vehicle includes attaching a mounting bar to a vehicle, inserting a spreader attachment or support frame into the mounting bar or support holder and connecting a power supply to a motor. Inserting a spreader into the spreader attachment and adding the media to be spread into the spreader. Engaging the spreader with the motor to operate the spreader by, in an exemplary embodiment, turning the axle of the wheels of the spreader. Setting and adjusting the spreader attachment and the spreader controls to accommodate the spreader and control the rate of media flow and motor speed at desired settings. The steps may be performed in any sequence in any fashion to operate the invention.

The instant invention also includes a method of assembling a device or kit for attaching a spreader to a vehicle. The method includes the steps of mounting a support mechanism to the vehicle, mounting a support frame on the support mechanism, mounting a spreader with wheels on the support frame, and engaging the wheels or axle of the spreader with a drive unit to drive the spreader. The steps may be performed in any sequence in a fashion to operate the instant invention. Further steps may also include adjustment steps to accommodate variations in the spreader or the vehicle and control steps to modify the rate of flow of material and speed of the drive unit.

The embodiments and examples discussed herein are non-limiting examples. The invention is described in detail with respect to exemplary embodiments, and it will now be apparent from the foregoing to those skilled in the art that changes and modifications can be made without departing from the invention in its broader aspects, and the invention, therefore, as defined in the claims is intended to cover all such changes and modifications as fall within the true spirit of the invention.

What is claimed is:

1. An attachment device as substantially described in the description and shown in the accompanying figures.

2. A method of attaching a spreader to a vehicle as substantially described in the description and shown in the accompanying figures.

3. A kit and method of assembling a kit as substantially described in the description and shown in the accompanying figures.

4. An attachment device attaching a push spreader having wheels to a vehicle, comprising:
an attachment frame having first and second attachment frame members;
at least a first and a second receiving elements that engage the spreader; and
a motor driving a contact member, wherein said contact member drives said wheels and an axle and operates the spreader.

5. The attachment device of claim 4, wherein the attachment frame is an L-shaped frame.

6. The attachment device of claim 4, wherein the at least first and second receiving elements further comprise a first receiving element extending from said first attachment frame member and a second receiving element extending from said second attachment frame member.

7. The attachment device of claim 5, wherein the first and second attachment frame members of the L-shaped attachment frame form an angle of between about 20 degrees and about 160 degrees relative to one another.

8. The attachment device of claim 7, wherein the first and second attachment frame members form an angle of about 90 degrees relative to one another.

9. The attachment device of claim 4, further comprising an angle adjustment mechanism, wherein said angle adjustment mechanism adjusts an angle of said first and second attachment frame members relative to one another.

10. The attachment device of claim 9, wherein the angle adjustment mechanism is a hinge with an adjustable securing mechanism at an apex of the attachment frame between said attachment frame members and the angle between the attachment frame members is adjustable between about 20 degrees to about 160 degrees relative.

11. The attachment device of claim 4, further comprising support mounts and a support mount holder.

12. The attachment device of claim 11, wherein the support mount holder is coupled to the vehicle and the support mounts engage said support mount holder.

13. The attachment device of claim 12, further comprising an elevation adjustment mechanism.

14. The attachment device of claim 13, wherein said elevation adjustment mechanism is proximate to said support mount holder.

15. The attachment device of claim 13, wherein said elevation adjustment mechanism is one of a toothed fastener, a toothed groove with adjustable holding pins, a rack and pinion mechanism, spring loaded push pins, or securing pins.

16. The attachment device of claim 4, further comprising at least one adjustment mechanism adjusting the position of at least one of said at least first and second receiving elements.

17. The attachment device of claim 5, further comprising at least one set of further receiving elements

18. The attached device of claim 17, wherein further receiving elements are located opposite one another.

19. The attachment device of claim 17, further comprising an adjustment mechanism for each receiving element.

20. The attachment device of claim 19, wherein each adjustment mechanism is a plate containing the receiving element coupled to the attachment frame with an adjustable fastening mechanism.

21. The attachment device of claim 20, wherein the adjustable fastening mechanism is a wing nut and a carriage bolt.

22. The attachment device of claim 17, wherein the at least one set of further receiving elements are separated equidistant relative to one another on said attachment frame.

23. The attachment device of claim 17, wherein the at least one set of further receiving elements are separated at a first distance relative to one another, this first distance being adjustable by an adjustment mechanism.

24. The attachment device of claim 16, further comprising an adjustment mechanism adjusting said first receiving element, and wherein the adjustment mechanism is a plate and a fastening mechanism coupling said plate to said attachment frame.

25. The attachment device of claim 16, further comprising an adjustment mechanism adjusting said second receiving element, and wherein the adjustment mechanism is a plate and a fastening mechanism coupling said plate to said attachment frame.

26. The attachment device of claim 4, further comprising a plurality of receiving elements.

27. The attachment device of claim 4, further comprising a means for controlling the speed of the motor.

28. The attachment device of claim 27, wherein said means for controlling is mounted on said vehicle apart from said motor.

29. The attachment device of claim 28, wherein said means for controlling said motor is removably affixed to the vehicle.

30. The attached device of claim 29, wherein said means for controlling said motor is removably affixed by a magnet.

31. An attachment device coupled to a vehicle and receiving a push spreader, the push spreader having a frame with an at least one set of legs and an at least one set of wheels on an axle, the device comprising:
an attachment frame having at least a first and a second member;
at least a first receiving element extending from said first member for engaging the at least one set of legs of the spreader; and
at least a second receiving element extending from said second member for engaging said at least one set of legs, while allowing for rotation of said wheels and axle; and
a motor driving a contact member that engages said wheels and said axle and operates the spreader through said engagement and rotation of the wheels.

32. The attachment device of claim 31, wherein the attachment frame is L-shaped.

33. The attachment device of claim 32, wherein the first and second members of the L-shaped attachment frame form an angle of between about 20 degrees and about 160 degrees relative to one another.

34. The attachment device of claim 33, wherein the first and second members of the L-shaped attachment frame form an angle of about 90 degrees relative to one another.

35. The attachment device of claim 31, further comprising an angle adjustment mechanism, wherein said angle adjustment mechanism adjusts an angle of said first and second attachment frame members relative to one another.

36. The attachment device of claim 35, wherein the angle adjustment mechanism is a hinge at an apex of the attachment frame and the angle between the members is adjustable between an angle of about 20 degrees to an angle of about 160 degrees relative to one another.

37. The attachment device of claim 31, further comprising support mounts and a support mount holder.

38. The attachment device of claim 37, wherein the support mount holder is coupled to the vehicle and the support mounts engage said support mount holder.

39. The attachment device of claim 38, further comprising an elevation adjustment mechanism.

40. The attachment device of claim 39, wherein said elevation adjustment mechanism is proximate to said support mount holder.

41. The attachment device of claim 31, wherein said elevation adjustment mechanism is one of a toothed fastener, a toothed groove with adjustable holding pins, a rack and pinion mechanism, a spring loaded push pin with holes, or securing pins.

42. The attachment device of claim 31, further comprising at least one adjustment mechanism adjusting the position of said at least first and second receiving members relative to said attachment frame.

43. The attachment device of claim 42, further comprising at least one set of further receiving members located opposite one another and at an angle to one of said at least first and second receiving members.

44. The attachment device of claim 42, further comprising an adjustment mechanism for each receiving member.

45. The attachment device of claim 44, wherein each adjustment mechanism is a plate containing the receiving element coupled to the attachment frame with an adjustable fastening mechanism.

46. The attachment device of claim 45, wherein the adjustable fastening mechanism is a wing nut and a carriage bolt.

47. The attachment device of claim 42, wherein the at least one set of further receiving members are separated equidistant relative to one another on said attachment frame.

48. The attachment device of claim 42, further comprising an adjustment mechanism for said first receiving element, and wherein the adjustment mechanism is a plate and a fastening mechanism coupling said plate to said attachment frame.

48. The attachment device of claim 43, further comprising an adjustment mechanism for said first receiving element, wherein the adjustment mechanism is a plate and a fastening mechanism coupling said plate to said attachment frame.

49. The attachment device of claim 43, further comprising an adjustment mechanism for said second receiving element, wherein the adjustment mechanism is a plate and a fastening mechanism coupling said plate to said attachment frame.

51. The attachment device of claim 31, further comprising a plurality of receiving elements.

52. The attachment device of claim 31, wherein the motor has a means for adjusting the speed of the motor.

53. The attachment device of claim 52, wherein said means for controlling is mounted on said vehicle apart from said motor.

54. The attachment device of claim 53, wherein said means for controlling said motor is removably affixed to the vehicle.

55. The attached device of claim 54, wherein said means for controlling said motor is removably affixed by a magnet.

56. A kit attaching a spreader with wheels to a vehicle comprising:
a mounting mechanism which is coupled to the vehicle;
a support frame which is coupled to the mounting mechanism and into which the spreader is inserted;
a drive unit mounted on the support frame so that the drive unit engages the wheels of the spreader.

57. A method of assembling a kit for attaching a spreader to a vehicle, comprising the steps of:
mounting a support mechanism to the vehicle;
mounting a support frame on said support mechanism;
mounting a spreader with wheels on said support frame; and
engaging the wheels of said spreader with a drive unit to drive the spreader.

58. An attachment device attaching a spreader having wheels to a vehicle, comprising:
a frame having first and second attachment frame members;
at least one receiving element that engage the spreader; and
a motor driving a contact member, wherein said contact member drives said wheels and operates the spreader.

59. The attachment device of claim 4, further comprising a motor adjustment mechanism.

60. The attachment device of claim 59, wherein the motor adjustment mechanism comprises adjustable motor adjustment securing members and a slot in a motor mounting bracket.

61. The attachment device of claim 4, wherein the contact member comprises one of a cylinder, a chain, and a band.

62. The attachment device of claim 4, wherein said contact member drives said wheels or said axle directly.

63. The attachment device of claim 27, wherein the means for adjusting the speed of the motor is a variable speed switch.

64. The attachment device of claim 52, wherein the means for adjusting the speed of the motor is a variable speed switch.

65. The attachment device of claim 4, wherein the push spreader is a broadcast spreader and the attachment device is attached to the front of the direction of travel of the vehicle.

66. The attached device of claim 18, wherein the further receiving elements that are located opposite one another are also at an angle to one of said at least first and second receiving elements.
